(19) United States
(12) Patent Application Publication
(10) Pub. No.: US 2010/0283656 A1
(43) Pub. Date: Nov. 11, 2010

(54) METHOD AND SYSTEM FOR JAMMING SIMULTANEOUSLY WITH COMMUNICATION USING OMNI-DIRECTIONAL ANTENNA

(76) Inventors: Robert J. ZAVREL, JR., Elmira, OR (US); Eric Taketatsu, Honolulu, HI (US)

Correspondence Address: Leighton K. Chong;IP & Patent Attorney, 133 Kaai Street, Honolulu, HI, 96821, US

(21) Appl. No.: 11/768,878

(22) Filed: Jun. 26, 2007

Related U.S. Application Data
(60) Provisional application No. 60/823,499, filed on Aug. 24, 2006.

(51) Int. Cl. G01S 7/38; H04K 3/00; H04B 1/713

(52) U.S. Cl. 342/14; 455/1; 375/135; 375/E01.033

(57) ABSTRACT

Double-sideband suppressed carrier (DSSC) modulation is used in concert with local oscillator (LO) rejection to create a steep notch for a communication signal within a jamming signal. The double-sideband suppressed carrier modulation may use upper and lower sidebands which are symmetrical or asymmetrical. An equivalent very high Q band-pass notch is synthesized within the jamming sideband signals. The jammer signal can be split into four signals in quadrature phases and fed to a four-square vertical dipole antenna design that results in a null along the axis of the array's center on which a communication antenna is aligned.

This U.S. patent application claims the priority of U.S. Provisional Patent Application 60/823,499 filed on Aug. 24, 2006, by the same inventor, and of the same title.

### TECHNICAL FIELD

The present invention relates to a method and system for simultaneous radio communications and radio frequency jamming.

### BACKGROUND OF INVENTION

There are often commercial or military applications where a narrow-band signal must be received inside the bandwidth of a wide bandwidth signal. For example, in cellular phone communications, a narrowband signal can be transmitted inside the bandwidth of an OFDM or CDMA wideband signal, such as a narrowband voice channel “implanted” in a wideband spread spectrum signal. This would permit using existing narrowband voice communications within a wideband signal, especially when receiving the narrowband signal while transmitting the wideband signal. Other users might want to optimize use of limited spectrum allocations.

As another example, for secure communications, it may be desirable to transmit a narrowband communication signal inside a wideband jamming signal, so that the communication signal can be received without interception. In hostile environments, there may be personnel in areas where radio-controlled improvised explosive devices (RCIED) present high risks. A fundamental problem has been that the jammer signal will interfere with (jam) the desired communication link. Therefore it has been necessary to “turn off” the jamming signal while receiving in the communication channel to avoid self-jamming. These frequency “openings” provide opportunities for RCIED operators to detonate their devices. Eliminating or greatly reducing these openings would present the RCIED operator a much more complex problem to overcome jamming. Such a development could greatly reduce risks of harm for humanitarian and aid workers and contractors working in locations where terrorist threats exist, as well as be beneficial for securing other communications environments such as cellular communication systems, and communications of public safety and security organizations (including Homeland Security), non-governmental organizations, executives and VIPs, and the military.

For example, U.S. Patent Appl. 2006/0264168, of Corbett, filed on May 19, 2005, and published on Nov. 23, 2006, discloses generating a wide-band jamming signal with open data channels (notches) by digital processing and filtering, for communication with authorized parties. U.S. Pat. No. 7,095,779 and Published Patent Appl. 2005/0041728 to Karlsson disclose a jamming system using “lockouts” providing no jam frequencies to authorized parties. U.S. Pat. No. 6,697,008 to Sternowski discloses a system for simultaneous jamming and communications. U.S. Published Patent Appl. 2004/0214520 to Jung discloses compressing communications signals and transmitting them during very brief time windows programmed in the jamming signal. U.S. Pat. No. 7,138,936 and Published Patent Appl. 2006/0164282 to Duff et al. disclose jamming RF-IEDs in the UWB spectrum while minimizing interference with desired communications signals. U.S. Pat. No. 4,103,237 to Fischer discloses a system that uses a shared antenna to transmit both communications and jamming signals simultaneously.

### SUMMARY OF INVENTION

It is therefore a principal object of the present invention to provide a method and apparatus for simultaneous communication with jamming in which sufficient jamming-to-communication isolation is obtained in order to reduce the presence of the jamming signal to an acceptable level at the communication receiver input in order to minimize or eliminate friendly communication receiver de-sensitization due to jammer interference.

In accordance with the present invention, double-sideband suppressed carrier (DSSC) modulation is used in concert with local oscillator (LO) rejection to create a very steep notch inside the jamming signal to permit reception and/or transmission of a communication signal within the notched jamming signal. The jamming signal can be any arbitrary waveform, including but not limited to pseudo-random noise (PRN), swept carrier, multi-carrier, comb, or any other signal. The DSSC modulation can be configured to create a symmetrical jamming signal in which upper and lower sidebands are substantially identical. In another mode, different upper and lower sideband signals are used to create an asymmetrical jamming signal.

A very high Q band-pass notch is synthesized within the jamming signals. In a preferred antenna design, the jammer signal is split into four signals in quadrature phases and fed to a four-square vertical dipole antenna array that results in a null along the axis of the array's center on which a communication antenna is aligned.

In another embodiment, the reception of a signal within a wideband noise signal may be adapted to measuring the amount of radio frequency (RE) energy in a narrowband inside of a wideband signal, such as in the case of Noise Power Ratio (NPR) measurements of communication electronics.

Other objects, features, and advantages of the present invention will be explained in the following detailed description of the invention having reference to the appended drawings.

### BRIEF DESCRIPTION OF DRAWINGS

FIG. 1A is a diagram of a preferred implementation of a method for jamming with simultaneous communication in accordance with the present invention.

FIG. 1B shows a circuit embodiment for a DSSC modulator for generating symmetrical jammer sidebands.

FIGS. 1C and 1D show versions of the jammer circuit synchronized with communications equipment through a local oscillator and through a synchronization control, respectively.

FIG. 1E illustrates a resultant signal profile of symmetrical jammer sidebands with a well-defined center notch for the communication signal.

FIG. 1F shows how a communication signal may be offset from the center of the notch to permit communication when carrier suppression is not sufficient.

FIG. 2A shows an alternate circuit embodiment of a DSSC modulator for generating asymmetrical jammer sidebands.

FIG. 2B illustrates the signal profile of the asymmetrical jammer sidebands resulting from the circuit of FIG. 2A.

FIG. 3 illustrates generating a jammer signal of further complexity using multiple DSSC modulator circuits and the resultant signal profile for the combined asymmetrical jammer sidebands.

FIG. 4 illustrates splitting the output jammer signal into four-phased jammer signals.

FIG. 5 shows an antenna assembly for transmitting the four-phased jammer signals with the communication signal.

FIG. 6 illustrates an embodiment using DDS for the technique

FIG. 7 illustrates using the invention in combination with an IED detection radar.

FIG. 8 illustrates using the invention for noise power ratio NPR measurements with a broadband analog noise source.

FIG. 9 illustrates using the invention for NPR measurements with a digitally generated PRN source and feedback circuitry for calibration.

### DETAILED DESCRIPTION OF INVENTION

In the following detailed description of the invention, certain preferred embodiments are illustrated providing certain specific details of their implementation. However, it will be recognized by one skilled in the art that many other variations and modifications may be made given the disclosed principles of the invention.

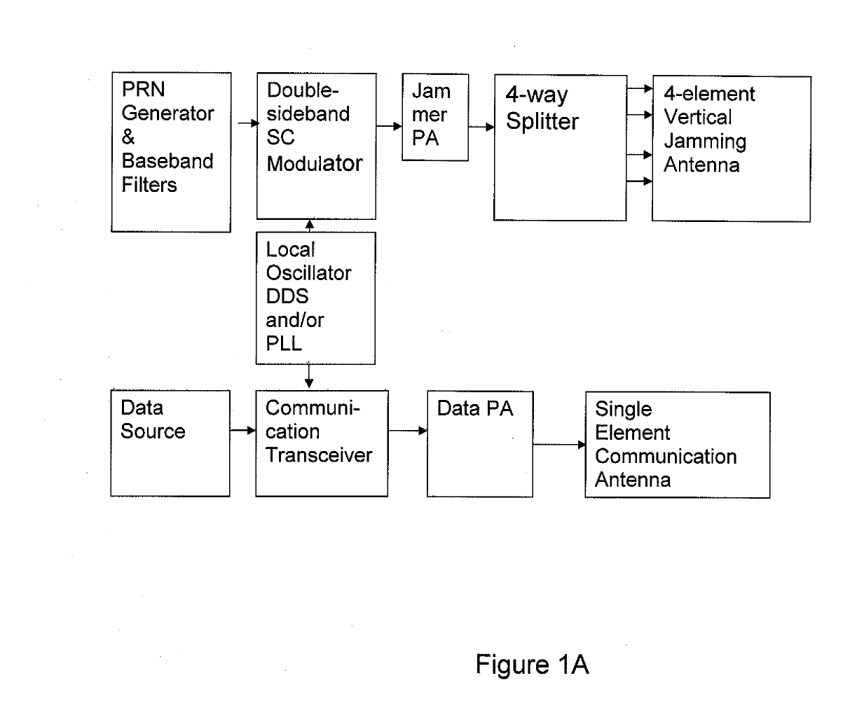

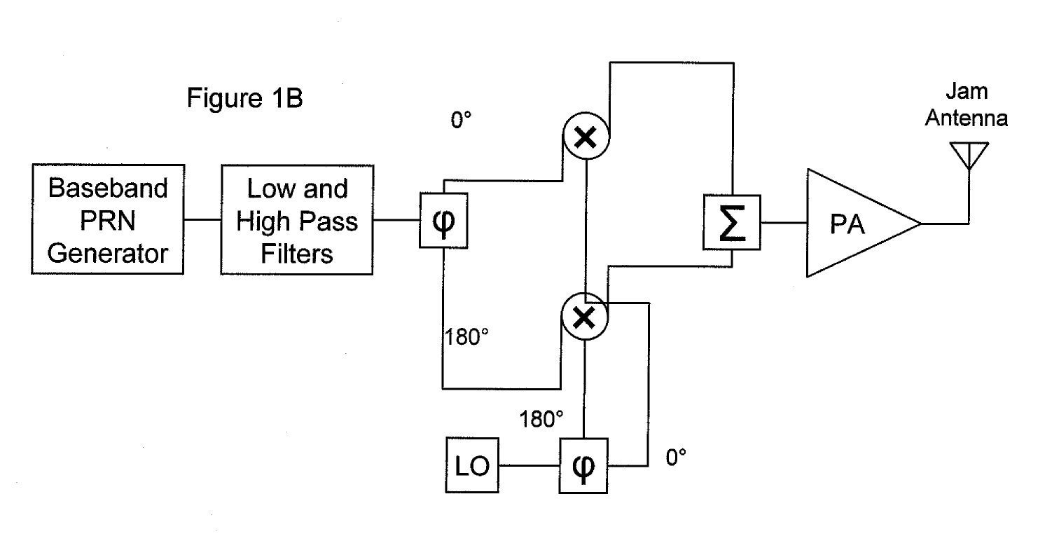

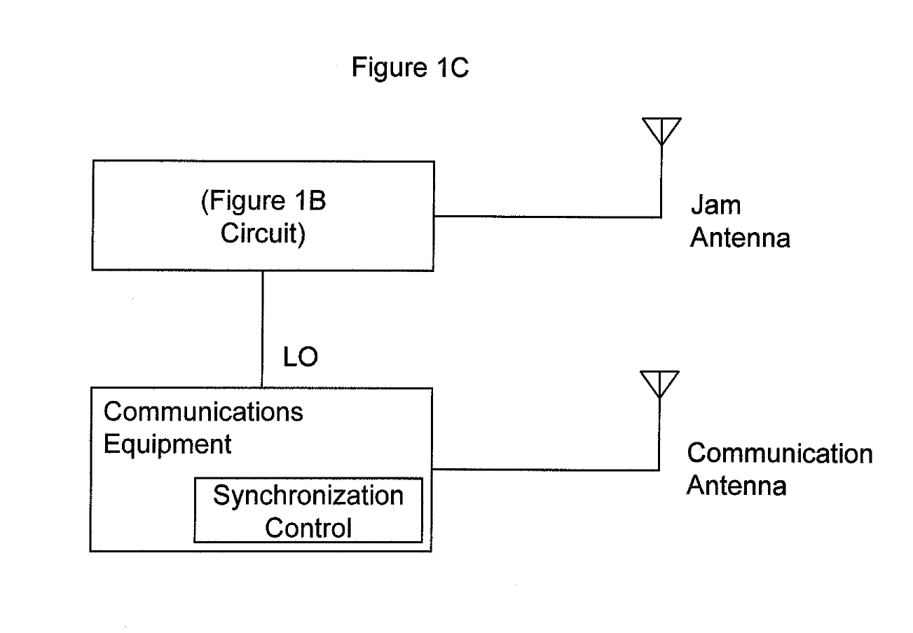

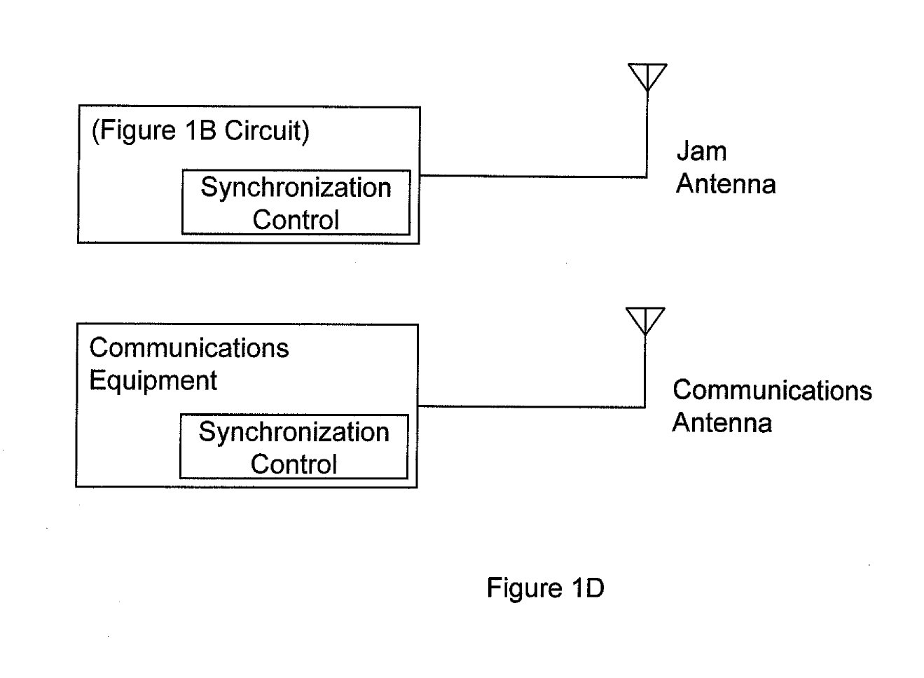

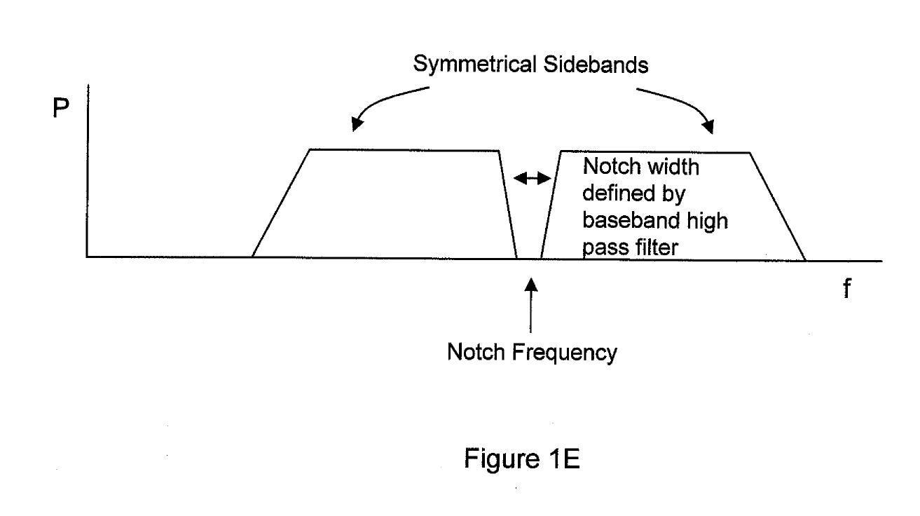

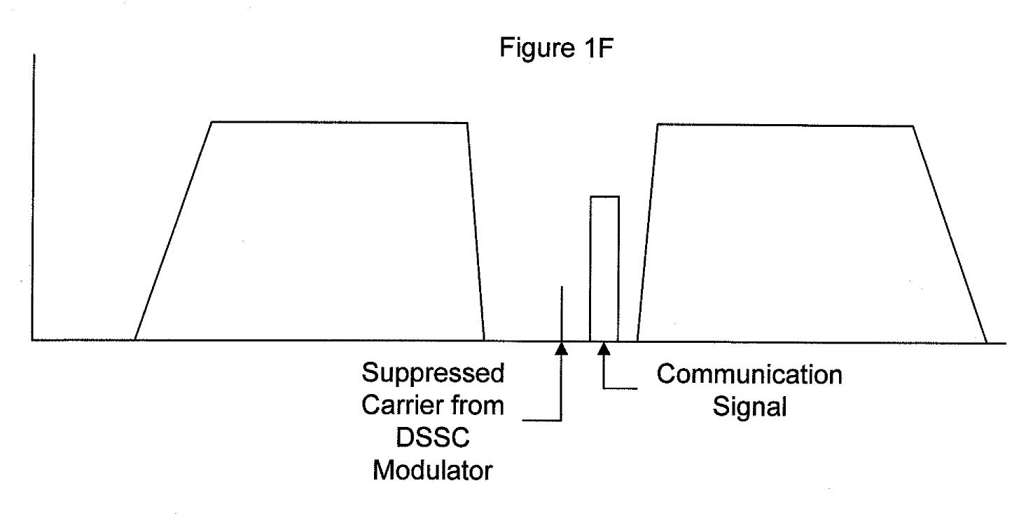

FIG. 1A shows a preferred implementation for the method of jamming with simultaneous communication in accordance with the present invention. A jamming signal is represented by a pseudo-random noise (PRN) digital sequence generated by a PRN generator with baseband filters. The jamming signal may instead be an analog white noise source, or any arbitrary jamming signal. The low-frequency (i.e., 0.2-10 MHz) jamming baseband signal is used to modulate a VHF local oscillator frequency (30-300 MHz), provided by a local oscillator (LO), which may be Direct Digital Synthesis (DDS) and/or Phase Lock Loop (PLL) type, on a double-sideband suppressed carrier provided by a DSSC modulator. The jamming baseband signal modulates the local oscillator producing the DSSC jamming signal with a very step notch. The jammer signal is amplified through a jammer power amplifier (PA) and fed to a 4-way splitter which splits the output jammer signal into four phased jammer signals. The four phased jammer signals are then transmitted through a 4-element vertical jamming antenna (described in further detail below). A communication transceiver synchronized with the local oscillator sends (and can also receive) a communication signal carrying data through a power amplifier (PA) and communication antenna (described in further detail below).

FIG. 1B shows a circuit embodiment of a DSSC modulator for generating symmetrical jammer sidebands. The output of a baseband PRN generator (or other jamming signal source) is fed through programmable low-pass and high-pass filters defining the bandwidths of both the notch and the overall jamming signal. Additional LO nulling is provided by the use of two double-balanced mixers (X) fed 180 degrees out-of-phase through an inverter with both the PRN and the LO signals. The two mixers (X) are used for LO isolation enhancement. The effect is to increase by about 30 dB the LO-to-RF isolation of a single mixer. The mixer outputs are summed by a summer (Σ) and fed to the jammer PA for amplifying to the jammer antenna. Alternatively, the VHF jammer signal could be fed to a second mixer for up-conversion to any higher frequency (UHF and microwave).

For the communication signal, referring again to FIG. 1A, a data source provides the data to be communicated to the communication transceiver which modulates the signal on the local oscillator frequency from the LO and sends the output to a data power amplifier (PA) which transmits the output communication signal through a single element communication antenna. As shown using either an LO or synchronization control in FIGS. 1C and 1D, the carrier frequency for the communication signal is synchronized so the notch bandwidth contains the communication frequency band. This can be accomplished by methods such as co-locating the invention with communications equipment such as the SINGARS Receiver-Transmitter RT-1523E(C)/U available from ITT Industries, Fort Wayne, Ind., or incorporating the synchronization circuitry into the communication equipment. However, phase locking is not necessary, but may be more convenient in certain applications.

FIG. 1E illustrates a resultant signal profile of the symmetrical jammer sidebands with a well-defined center notch for the communication signal. The notch frequency is the carrier frequency of the communication signal. The notch width is defined by the baseband high-pass filter. Since the notch is formed at baseband, a very steep notch filter can be obtained when viewed as actual dB/Hz. The dB/Hz roll-off is thus translated directly to the operating frequency. At the VHF operating frequency the equivalent Q is very high, but at baseband it can be synthesized using simple passive LC filter techniques.

FIG. 1F illustrates an alternate method where the communication frequency can be located at an “offset” from the DSSC jammer carrier frequency. The DSSC jammer carrier frequency would be tuned to allow the offset to be maintained. The communication signal can thus be located in the notch between jammer sidebands but without interference from the DSSC jammer carrier frequency. This method could be used for narrowband, high sensitivity radios where it may be impractical to attenuate the DSSC jammer carrier frequency to a sufficient level.

The communication signal can thus be handled simultaneously with the jamming signal while maintaining a high degree of communication-to-jamming signal isolation. The DSB technique can provide more than 40 dB of carrier suppression, and the actual jamming signal is (by definition) nulled at the communications frequency. This creates a deep band-stop effect on the jamming signal in the receive channel, in effect “opening” only that channel to communications. The technique creates a “brick wall” effect which is very difficult to achieve using notch filters at RF frequencies of about 1 GHz.

The total potential carrier suppression can combine the effects of modulator suppression (about 40 dB) plus dual mixer phasing cancellation (about 30 dB), for about 70 dB total. Antenna isolation suppresses the jam signal within the front-end band-pass of the receiver at about 30 dB at VHF. This can provide about 100 dB total LO suppression. Antenna isolation alone may not be adequate to protect the communication receiver front-end from the jammer noise. An additional 30 dB (approximate) of phase nulling may be required at the receiver front-end to prevent spectrum re-growth inside the null. For co-located jammer and communications equipment additional jammer nulling can be accomplished using relatively simple phase and amplitude balance circuitry at the communication radio input.

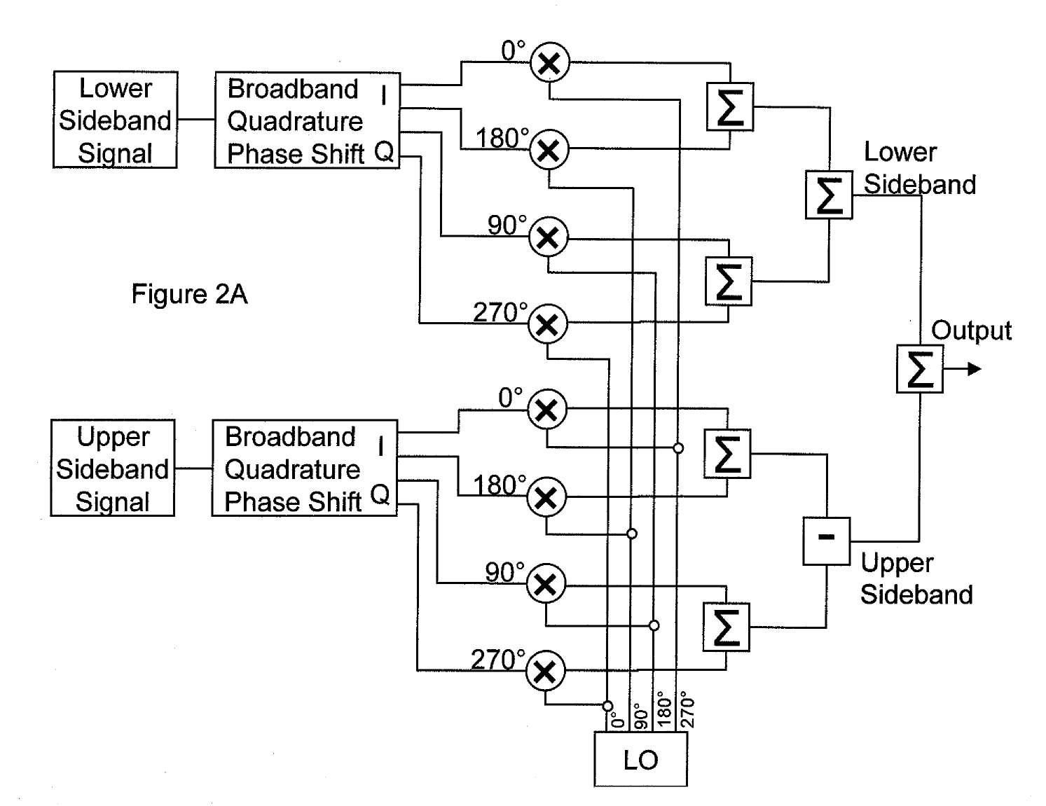

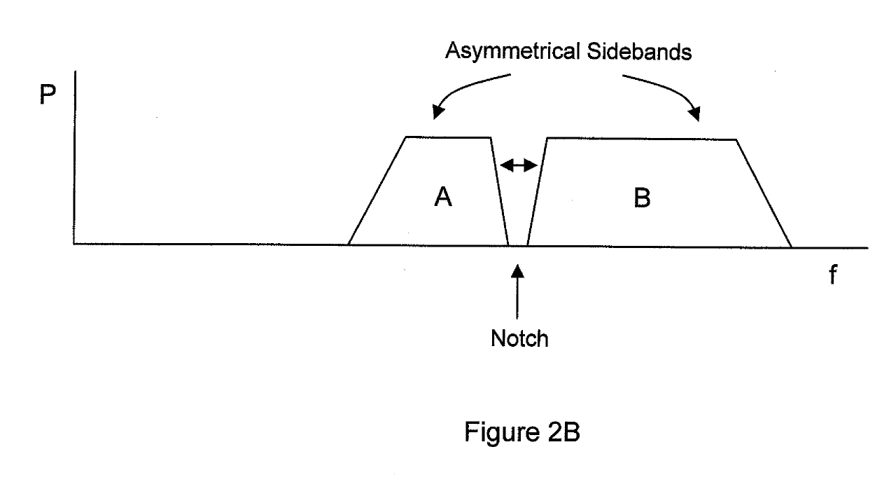

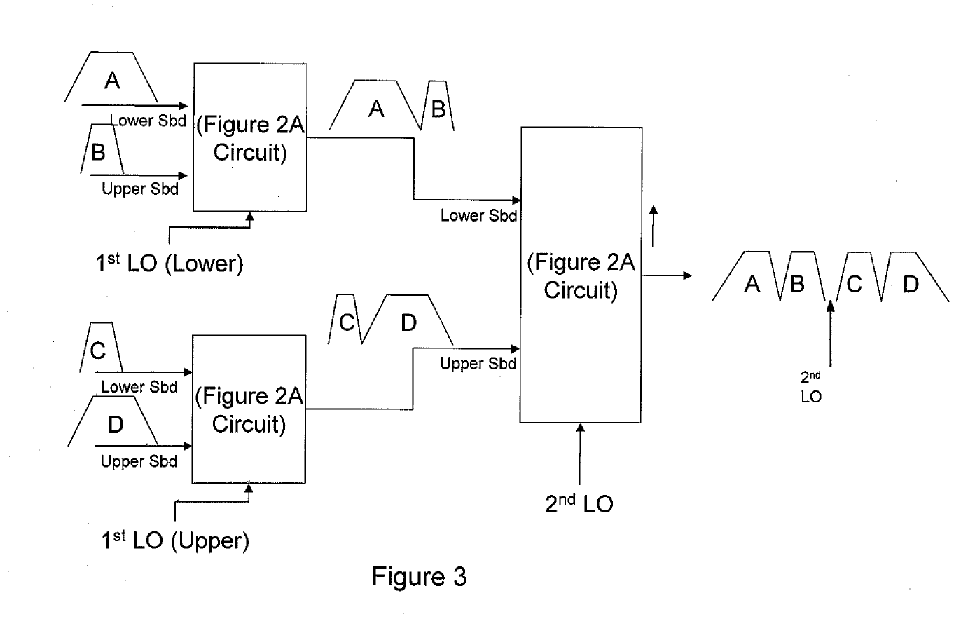

FIG. 2A shows an alternate embodiment of a DSSC modulator for generating asymmetrical jammer sidebands forming the communications notch. This technique uses the well-known technique of “phasing method” for single-sideband modulation. In this case two phasing circuits are used, one for the upper sideband signal and one for the lower sideband signal. A lower sideband signal generator provides a jam signal output that is converted to four signals in quadrature phases through a broadband quadrature phase shifter, such as a Hilbert transform unit, and fed to four mixers (X) where they are modulated with LO signals of respective phases generated by the local oscillator LO. The mixed signals that are 180 degrees out-of-phase with each other are summed in respective summers (Σ) for LO nulling, and the outputs thereof are combined by a summer to output the lower sideband jammer signal. Similarly, an upper sideband signal generator provides a jam signal output that is converted to four signals in quadrature phases and fed to four mixers (X) where they are modulated with LO signals of respective phases generated by local oscillator LO. The mixed signals that are 180 degrees out-of-phase with each other are summed in respective summers (Σ) for LO nulling, and the outputs thereof are combined and inverted by inverter (−) to output the upper sideband jammer signal. The upper and lower sideband jammer signals are then combined by an output summer (Σ). The eight mixers are thus used to permit simultaneous upper and lower sideband generation with LO isolation enhancement. This technique permits placing the jamming null anywhere inside a fixed jamming bandwidth.

FIG. 2B illustrates the signal profile of the asymmetrical jammer sidebands resulting from the circuit of FIG. 2A. One sideband B has a broader bandwidth than its counterpart sideband A, and the two sidebands frame the notch for the communication signal in between them.

FIG. 3 illustrates generating a jammer signal of further complexity using multiple DSSC modulator circuits to modulate asymmetrical double-sideband jammer signals. As shown in FIG. 2A, a lower asymmetrical waveform generator, using the circuit in FIG. 2A to combine a lower sideband component A with an upper sideband component B on a lower sideband carrier frequency provided by a first-stage LO, generates an asymmetrical lower sideband jammer signal AB. Matched in parallel is an upper asymmetrical waveform generator, also using the circuit in FIG. 2A to combine a lower sideband component C with an upper sideband component D on an upper sideband carrier frequency provided by another first-stage LO, which generates an asymmetrical upper sideband waveform CD. The two asymmetrical waveforms, in turn, are fed as upper and lower jam input signals in the same method of modulation with a second-stage LO to create a more complex asymmetric jammer signal ABCD from combining the two asymmetrical jammer waveforms. Each intermediate waveform, i.e. AB and CD, has a notch, and the combination has a third notch between the bands B and C. Each notch separation among the three notches would be instantly programmable by filter and 1^{st} and 2^{nd} LO alignment. In principle, this technique could be used to provide increasingly complex jammer waveforms with multiple notches.

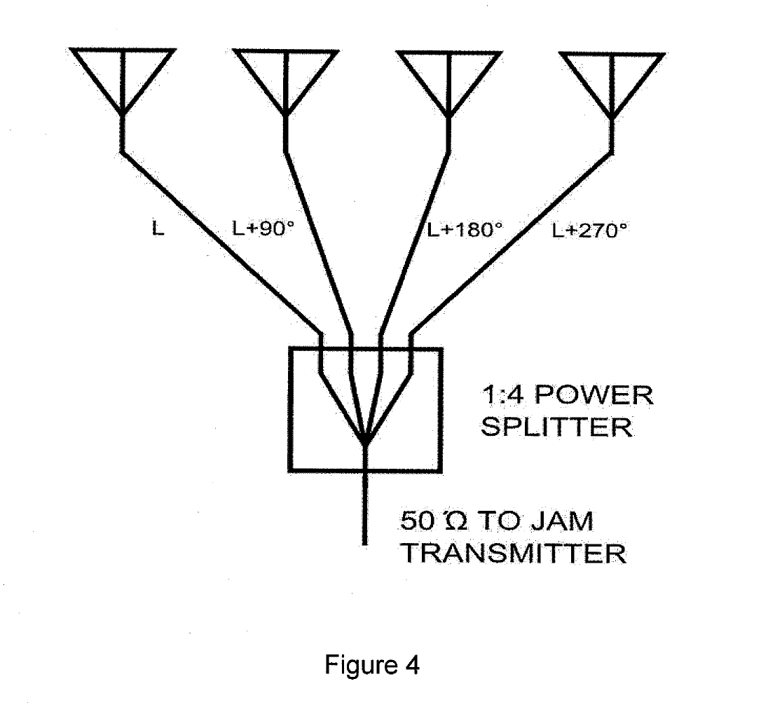

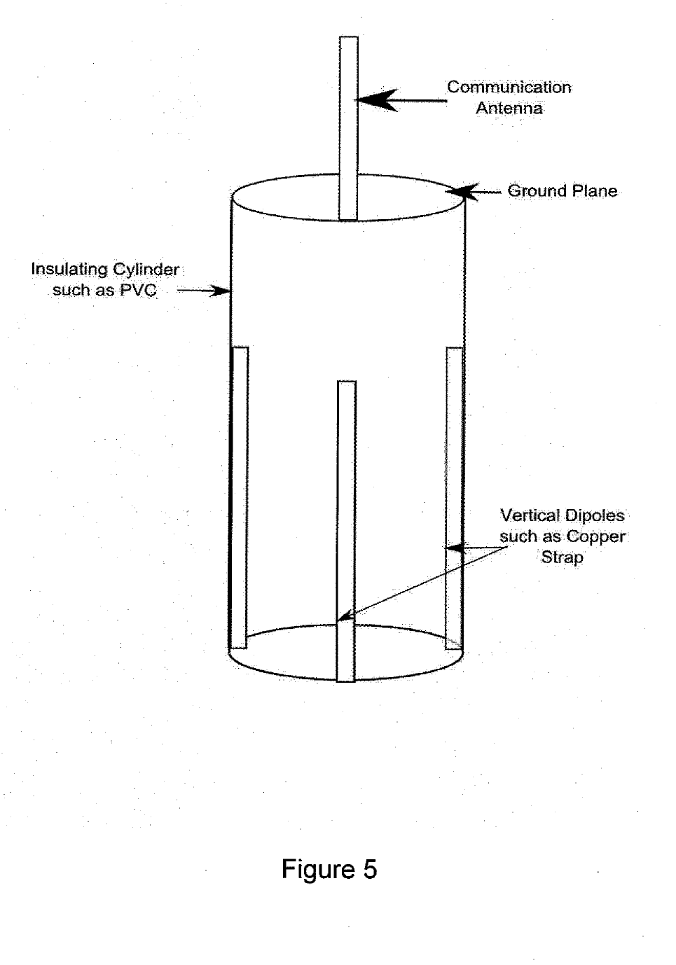

FIGS. 4 and 5 illustrate the transmission of the output jammer signal simultaneously with the communication signal. The jammer signal is fed to a 4-way splitter. The four outputs are used to drive phase delay lines to result in four signals in phase increments of 0, 90, 180, and 270 degrees. The four phased jammer signals are fed to four antennas. In the preferred arrangement shown in FIG. 5, the four antennas are vertical dipoles formed in a square configuration with each other, similar to a “four-square” array. These may be formed as vertical copper straps fixed to the circumference of an insulating center made of a material such as PVC. The orientation of the antennas combined with the sequential phasing results in a null along the axis of the array's center. A communication antenna for the communication signal is mounted on a ground plane at the upper end of the insulating cylinder and aligned with the axis of the array's center. Theoretically, infinite nulling is possible for the single element vertical antenna located on this axis. This antenna design optimizes isolation between the communication and jamming antennas on a single mast. Alternatively, any two antennas can be used, one for the communication signal and one for the jammer signal. The main objective to antenna design is to maximize isolation between the jammer and communications antennas. The quadrant technique is one of many possible configurations to that desired end.

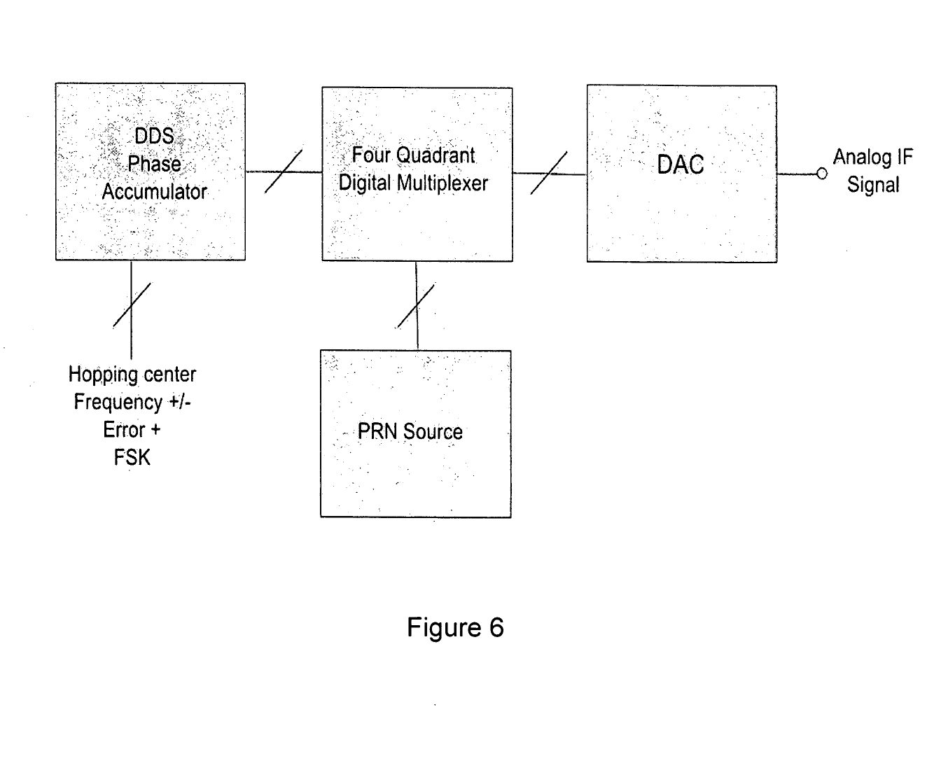

FIG. 6 illustrates an embodiment using direct digital synthesis techniques. In this example the circuit is used to synthesize a frequency hopping notch. However the other embodiments can also be used in FH applications as well. PRN source 40 provides a PRN digital sequence to a four quadrant digital multiplexer 41 which multiplexes it with the output of a DDS phase accumulator 42 fed by a frequency-hopping communications unit. The multiplexed signal is fed to a digital-to-analog converter (DAC) 43 which outputs an analog IF signal as the jamming signal.

Other modifications and enhancements may be made to improve performance. PLL and auto-nulling circuits could be used to nearly eliminate the leakage carrier (the LO). This is much easier than notching a complex jam signal since the carrier is monotonic and, at the receiver, deterministic. Bessell Function nulling can be used if FM is used as the jam signal. The communication channel can be placed between the carrier and one of the jam sidebands, if the carrier suppression proves inadequate and/or if a baseband scheme not employing coherent FSK is chosen. In this case the communications and jamming signals are not phase-locked. Spectrum re-growth in the jammer power amplifier can be minimized by using pre-distortion (particularly if DDS is used as the synthesizer) or by using feed-forward techniques. These techniques are particularly well suited for narrow-band applications, and the generated notch between sideband components can be modeled as a narrowband signal.

An added layer of security can be provided if both stations use a frequency-hopping system. In this system, the jamming band-stop simply hops with the instantaneous communications channel. This final layer of security would make it very difficult for the operator of an RCIED to “find” an opening. The net result is that both stations could jam the entire spectrum constantly except a narrow dynamic band-stop on the communications channel (e.g. hopping). The jammer signal with a deep null at the communication channel can focus on selected frequency bands. Additional jammers could provide jam signals farther away (spectrally) from the communication channel.

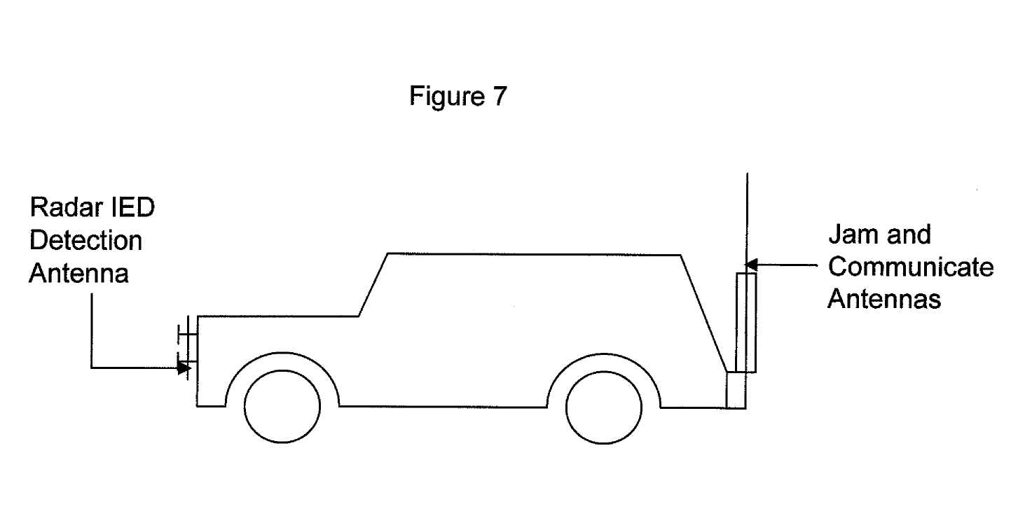

The above simultaneous jamming and communications method can be combined in a system that provides for simultaneous jamming, radar detection of improvised explosive devices (IEDs) and communications. A radar transmitter can be used as the jammer transmitter, which is typically an ultra-wide-band (UWB) system. The invention method is then used to notch the UWB signal as previously described. A separate radar receive antenna is provided on the front of a carrier vehicle as in FIG. 7. This can provide excellent isolation for the radar system and is properly oriented for an IED detector in front of the vehicle. Such a system could simultaneously jam RCIEDs while sending a communication signal, and be able to detect wire-controlled IEDs.

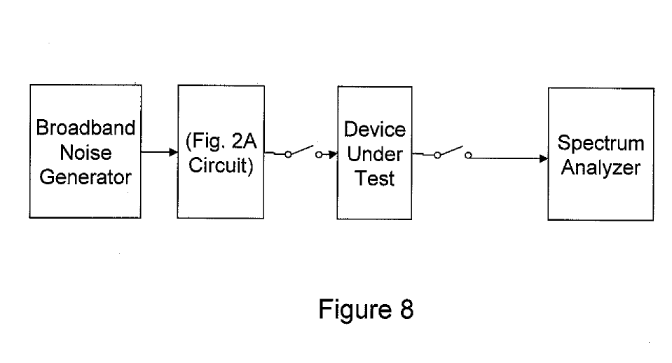

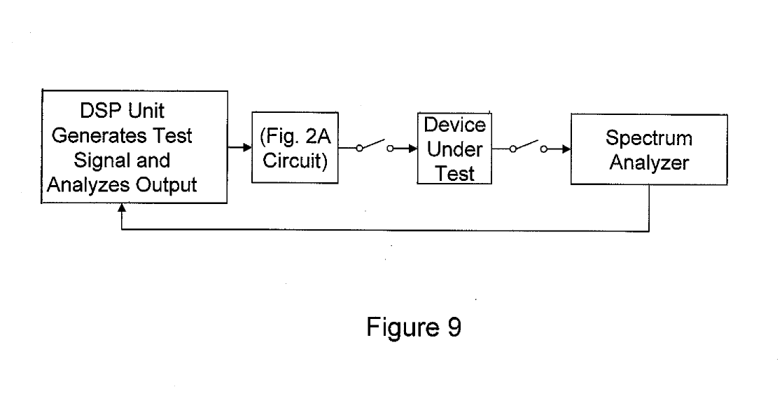

The invention can also be used to produce a tunable broadband NPR measurement waveform which removes the necessity of using RF notched filters for the frequency of interest by filtering at the baseband. The DSSC modulator can be used in conjunction with white Gaussian noise sources, as in FIG. 8, or digital signal processing to generate the noise waveform, as in FIG. 9, required for NPR measurements. Traditionally using a shaped white Gaussian noise source in NPR measurements takes much more time to conduct because the test are not repeatable (waveform is random) and takes longer to converge. Prior art shows that through DSP one can conduct a very effective NPR measurement that is repeatable because the test NPR waveforms can be generated deterministically. The advantage of using the invention is that it results in an increased notch depth than is traditionally observed with white Gaussian noise techniques of NPR waveform generation, thereby allowing for more sensitive measurements. It also has the advantage of reducing system complexity by minimize filter count and allows the notch to move through a range of frequencies much more quickly than switching filters.

It is to be understood that many modifications and variations may be devised given the above description of the principles of the invention. It is intended that all such modifications and variations be considered as within the spirit and scope of this invention, as defined in the following claims.

1. A system for simultaneously handling a communication signal with a jamming signal comprising:
(a) a jamming signal generator for generating a jamming signal of a desired type;
(b) a local oscillator (LO) for generating a local oscillator signal of a desired frequency;
(c) a double-sideband suppressed carrier modulator for modulating the jamming signal into a modulated jammer signal having two sideband components with local oscillator frequency rejection thereby forming a steep notch between them encompassing the local oscillator frequency; and
(d) a communication signal antenna and circuitry for handling a communication signal modulated at or near the local oscillator frequency and positioned within the notch formed between the sideband components of the modulated jammer signal, thereby enabling jamming simultaneously with handling of the communication signal.

2. A system according to claim 1, wherein the communication signal circuitry is configured to send and/or receive a communication signal that is modulated with the local oscillator frequency.

3. A system according to claim 1, wherein the communication signal is modulated at a carrier frequency slightly offset from the local oscillator frequency while being positioned within the notch between the two sideband components.

4. A system according to claim 1, wherein the double-sideband suppressed carrier modulator generates symmetrical jammer sideband components.

5. A system according to claim 1, wherein the double-sideband suppressed carrier modulator generates asymmetrical jammer sideband components using two single-sideband generators.

6. A system according to claim 1, wherein the jamming signal generator is a pseudo-random noise (PRN) generator with programmable low-pass and high-pass filters for defining the bandwidths of the notch and jamming sideband components.

7. A system according to claim 1, wherein the double-sideband suppressed carrier modulator generates asymmetrical jammer sideband components using a lower sideband jam signal generator to provide an output that is converted to four signals in quadrature phases and fed to four mixers where they are modulated with LO signals of respective quadrature phases and mixed with the signals that are 180 degrees out-of-phase with each other for LO nulling and then combined to result in a lower jammer sideband component, and an upper sideband jam signal generator to provide an output that is converted to four signals in quadrature phases and fed to four mixers where they are modulated with LO signals of respective quadrature phases and mixed with the signals that are 180 degrees out-of-phase with each other for LO nulling and then combined in an upper lower jammer sideband component, and the upper and lower jammer sideband components are combined to form the asymmetrical jammer sideband components.

8. A system according to claim 7, wherein the signal comprising the upper and lower jammer sideband components are modulated through a second double sideband suppressed carrier modulator to generate asymmetrical jammer sideband components resulting in a triple-notched signal.

9. A system according to claim 1, wherein the jammer signal is fed to a 4-way splitter and phase delay lines to result in four signals in phase increments of 0, 90, 180, and 270 degrees, and the four phased jammer signals are fed to four antennas to create a steeply nulled antenna pattern for greater jamming-to-communication isolation.

10. A system according to claim 9, wherein the four antennas are vertical dipoles of an array formed in a square configuration with each other, and the orientation of the antennas combined with sequential phasing results in an antenna null along a center axis of the array.

11. A system according to claim 10, wherein the four antennas are formed as vertical elements fixed to the circumference of a cylinder made of insulating material.

12. A system according to claim 11, wherein the communication signal antenna for transmitting the communication signal is mounted on a ground plane at an upper end of the insulating cylinder and aligned with the center axis of the array.

13. A system according to claim 1, wherein the jamming signal generator is frequency-hopping synchronous with a frequency hopping communications channel implemented by a hopping jammer local oscillator.

14. A method for simultaneously handling a communication signal with a jamming signal comprising:
(a) generating a jamming signal of a desired type;
(b) generating a local oscillator signal of a desired frequency;
(c) modulating the jamming signal into a modulated jammer signal having two sideband components with local oscillator frequency rejection thereby forming a steep notch between them encompassing the local oscillator frequency;
(d) handling a communication signal that is modulated at or near the local oscillator frequency and positioned in the notch between the two jammer sideband components.

15. A method according to claim 14 used for simultaneous jamming and radar detection of improvised explosive devices (IEDs) and communications on a military carrier vehicle, wherein a radar transmitter is used as the jammer transmitter and a radar receiving antenna is provided on the front of the carrier vehicle as an IED detector.

16. A method according to claim 14 used for noise power ratio (NPR) measurements with a broadband analog noise source.

17. A method according to claim 14 used for noise power ratio (NPR) measurements with a digitally generated pseudo-random noise (PRN) source.

18. A method according to claim 16, wherein the modulating of the jamming signal creates an increased notch depth greater then conventional filtering techniques used with NPR waveform measurement, thereby allowing for more sensitive measurements.

19. An antenna for simultaneously handling a communication signal with a jamming signal comprising:
(a) four antennas formed as vertical dipoles of an array formed in a square configuration with each other, each adapted to receive a respective one of four jammer signals in phase increments of 0, 90, 180, and 270 degrees, wherein the orientation of the antennas combined with sequential phasing results in a null along a center axis of the array; and
(b) a communication antenna for handling a communication signal aligned with the center axis of the array.

20. An antenna according to claim 19, wherein the four antennas are formed as vertical elements fixed to the circumference of a cylinder made of insulating material, and the communication antenna is mounted on a ground plane at an upper end of the insulating cylinder.
